(19) United States
(12) Patent Application Publication
(10) Pub. No.: US 2012/0266096 A1
(43) Pub. Date: Oct. 18, 2012

(54) INPUT ENCODING FOR HAND HELD DEVICES TO SIMPLIFY INPUT BY A USER

(76) Inventor: Darren Gold, San Jose, CA (US)

(21) Appl. No.: 13/086,345

(22) Filed: Apr. 13, 2011

(51) Int. Cl. G06F 3/048

(52) U.S. Cl. 715/773

(57) ABSTRACT

Data specifiers to delineate the format of the input to a device. By knowing the format of the expected input, the device automatically switches displayed input touchpads to a touchpad most appropriate for the input of a current character of data. In this way, users are alleviated from manually switching between touchpads.

### BACKGROUND OF THE INVENTION

Hand held devices such as iPhones and Droid based devices are becoming more prevalent. These devices allow users to interactively search for and receive information. In addition, the devices allow people to interact with information or service providers such as data aggregators, on-line encyclopedias, on-line stores, credit card companies and airlines. These information and service providers supply web-pages with data fields for inputting text.

Users that use these handheld devices have several ways to provide information to the information and service providers. These include clinking on links to move to a new location or inputting data into input data fields.

To input information into the input data fields, a user uses a touchpad on a screen of the handheld device to type in symbols such as letters and numbers. However, with many hand held devices the screen is unable to hold on a single screen the full range of characters that users need. Thus, the user is forced to switch between various touchpads to input the data into the input data field. For instance, the touchpads for the iPhone include a numeric touchpad, an alphabet touchpad and a symbol touchpad in order to provide the user a full allotment of characters. The switching between touchpads is performed manually by the user.

The input data fields that users input information into are generic and do not allow for specific inputs and thus a user may need to manually switch between touchpads. In addition, the device checks for spelling errors in the user input into the input data field, even if the input is not expected to be a properly spelled word. This leads a user to be forced to manually keep the spellcheck from automatically replacing the information inputted by the user.

What is needed is a method and system to allow a user to not manually switch between touchpads. In addition, what is also needed is a method and system to prevent a user from having to suppress a spellcheck feature when the spellcheck feature is not needed.

### SUMMARY OF THE INVENTION

In order to address the gap in the current technology, several methods and systems are described. The methods and systems allow a device with an input data field to behave in a more automatic manner in order to alleviate burdens on a user.

A data specifier, such as an HTML tag, to delineate the type or format of input in an input data field helps a device to automatically adapt for a user. Specifically the data specifier can specify the format of the input data field or specify that the input is expected to be a non-standard word.

The data specifier can delineate the format of the input. By knowing the format of the expected input, the device can automatically switch the displayed input touchpads to the one most appropriate for the input of a current character of data.

The data specifier can delineate an input which is not expected to be a standard word in a dictionary. In this way the device can automatically disable the spell check from executing on the input or enable a non-standard dictionary.

By automatically changing the displayed input touchpad and suppressing a spell check feature, a device helps a user save time by allowing the user to not be required to switch the displayed input touchpad or to reject a spell check suggestion.

The data specifier need not be an HTML tag, but can be any generic method of providing information about an input data field.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a hand held device;

FIG. 2 is a hand held device displaying a touchpad for the input data field of alphabetic characters;

FIG. 3 is a hand held device displaying a touchpad for the input data field of numeric characters;

FIG. 4 is a hand held device displaying a touchpad for the input data field of symbolic characters; and

FIG. 5 is a hand held device with data in an input data field.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The systems described herein may be implemented with components or modules. The components and modules may include hardware (including electronic and/or computer circuitry), firmware and/or software (collectively referred to herein as “logic”). A component or module can be implemented to capture any of the logic described herein. The firmware and/or software may be for instance an operating system.

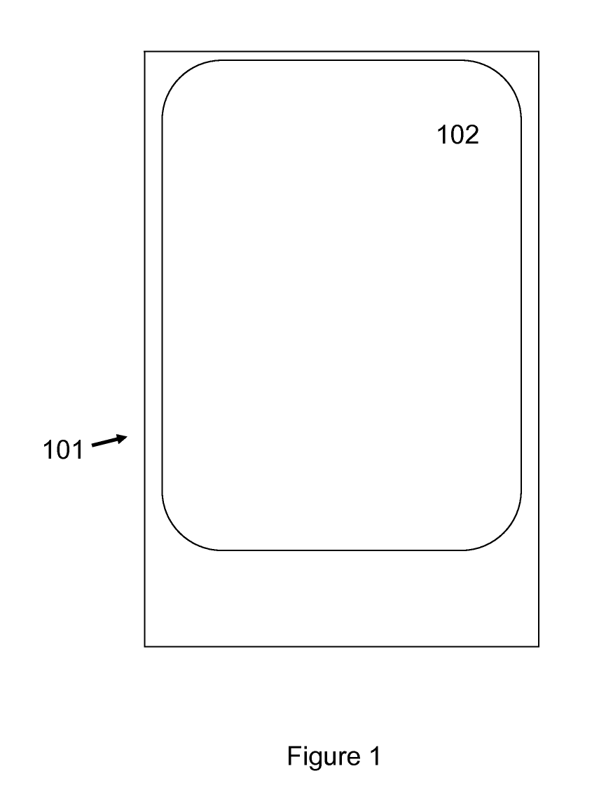

FIG. 1 is a representation of a hand held device 101 that allows users to interactively search for and receive information. The hand held device has a display such as a display screen 102. The display screen displays information retrieved by the user such as web pages, touchpads for input data fields, input data fields and many other items.

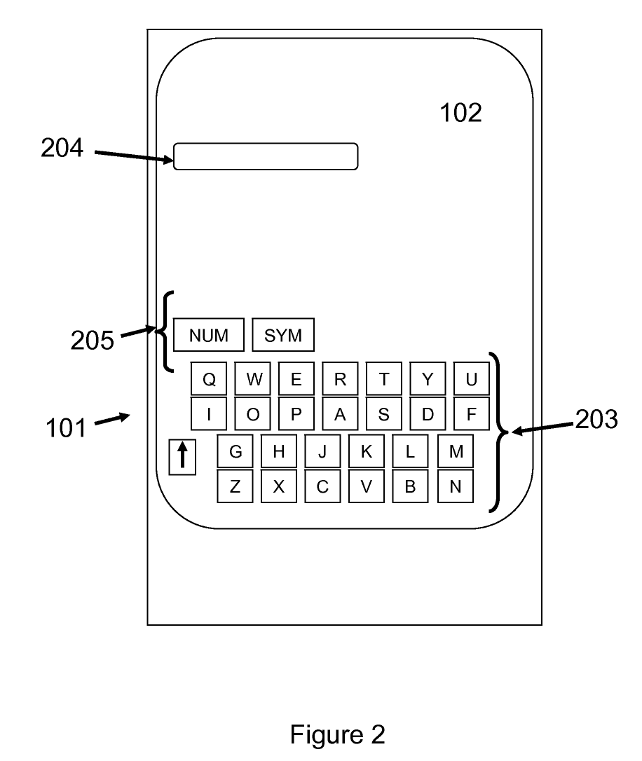

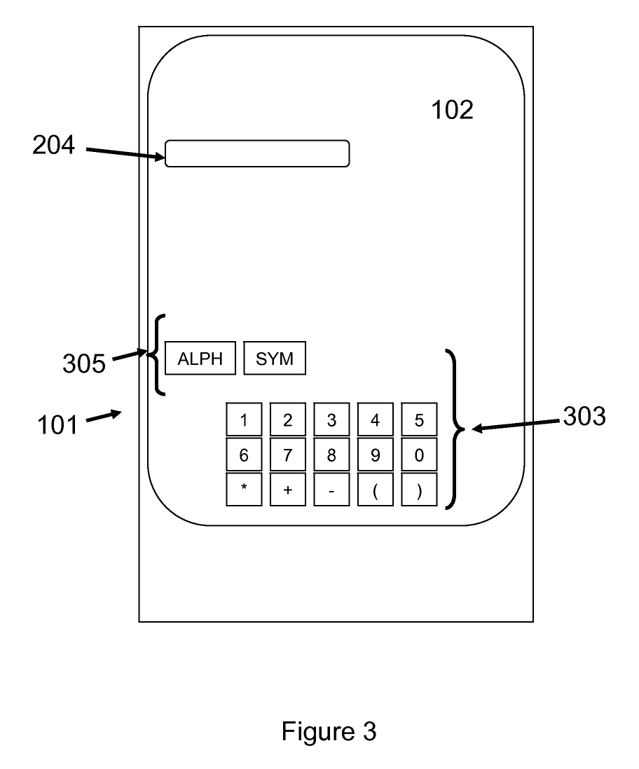

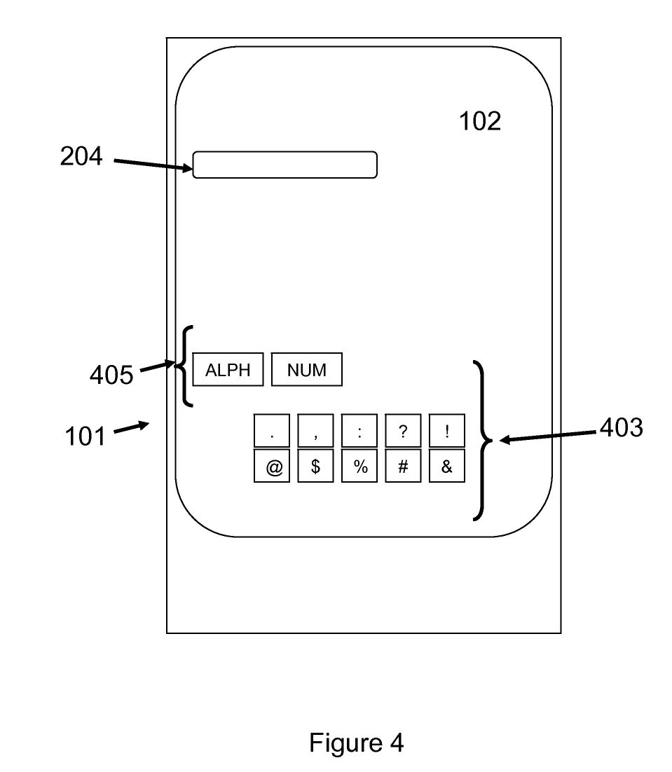

FIG. 2 is a representation of hand held device 101 with display screen 102 displaying a touchpad for the input of alphabetic characters 203. Handheld device display screen 102 also displays input data field 204 into which the input from the user is typed. Additionally, handheld device display screen 102 displays “NUM” and “SYM” buttons 205. When the “NUM” button is pressed, logic of the device changes the displayed input touchpad to a numeric touchpad as shown in FIG. 3. Similarly, when the “SYM” button is pressed, logic of the device changes the displayed input touchpad to a touchpad of symbolic characters as shown in FIG. 4.

FIG. 3 is a representation of hand held device 101 with display screen 102 displaying a touchpad for the input of numeric characters 303. Handheld device display screen 102 also displays input data field 204 into which the input from the user is typed. Additionally, handheld device display screen 102 displays “APLH” and “SYM” buttons 305. When the “ALPH” button is pressed, logic of the device changes the displayed input touchpad to an alphabetic character touchpad as shown in FIG. 2. Similarly, when the “SYM” button is pressed, logic of the device changes the displayed input touchpad to a touchpad of symbolic characters as shown in FIG. 4. The numeric characters may include symbols often used with numbers such as “(”, “)”, “+”, “−” and “*”.

FIG. 4 is a representation of hand held device 101 with display screen 102 displaying a touchpad for the input of symbolic characters 403. Handheld device display screen 102 also displays input data field 204 into which the input from the user is typed. Additionally, handheld device display screen 102 displays “APLH” and “NUM” buttons 305. When the “ALPH” button is pressed, logic of the device changes the displayed input touchpad to an alphabetic character touchpad as shown in FIG. 2. Similarly, when the “NUM” button is pressed, logic of the device changes the displayed input touchpad to a numeric touchpad as shown in FIG. 3.

By manually switching between the different touchpads 203, 303 and 403 a user is able to enter more complex data. For instance to insert a date with the format MM/DD/YYYY the user would need to switch the touchpad four times. Specifically the user would (1) enter two numbers for the month, (2) press the “SYM” button, (3) enter a slash, (4) press the “NUM” button, (5) enter two numbers for the day of the month, (6) press the “SYM” button, (7) enter a slash, (8) press the “NUM” button and (9) enter four numbers for the year. The user has to waste button presses by switching between the various touchpads. In this case, the number of wasted button presses is the four needed to switch between the touchpads.

The input data field may include a format data specifier which allows the device to automatically switch between displayed input touchpads. For instance for a date with the format MM/DD/YYYY the input data field can include the following format data specifier: “NNSNNSNNNN”. Generically, an input data field may have the following format data specifier symbols:

A: Alphabetic character

N: Numeric character

S: Symbolic character

Further, “FDS:” could precede the format of the input data as a generic indicator to the device that a format is being specified. For example, the format data specifier would be “FDS:NNSNNSNNNN”

Of course additional data specifier symbols can be adopted such as identifiers for languages that do not use the English alphabet or for specifically scientific symbols. Also, identifier symbols can be used for portions of a set of characters such as F for the first half of the alphabet (A-M). Generally, data specifier symbols can be adopted to match any input touchpad provided.

When logic of device 101 loads the input data field 204 it also loads any associated data specifier. The data specifier provides the device and its logic information to automatically change the displayed touchpad. For instance, if an input data field with a format of “NNSNNSNNNN” is provided to device 101 the logic of device may automatically change the displayed input touchpad for the user. When the user selects the input data field 204, the numeric character touchpad is automatically displayed for the user. After the user inputs two numeric characters, the logic of the device 101 automatically changes the touchpad displayed to the symbolic character touchpad. After entry of a symbolic character, the logic of the device 101 automatically displays the numeric touchpad. This process continues until the input data field 204 is filled as described in the format associated with the input data field by the data specifier. In addition, if the user deletes the last character, logic of the device 101 changes the displayed touchpad to the touchpad associated with the previous character. Logic of the device 101 also changes the displayed touchpad to a default touchpad if the next expected character of the format identifier a null or a blank.

In general, logic of the device 101 performs a method for selecting a touchpad to present to a user on a device. The steps include (1) receiving a format identifier corresponding to an input data field; (2) displaying a touchpad on a display corresponding to a next expected input in the input data field as specified by the format identifier; (3) receiving input in the input data field; and (4) changing the touchpad displayed on the display to correspond to the next expected input after receiving input in the input data field.

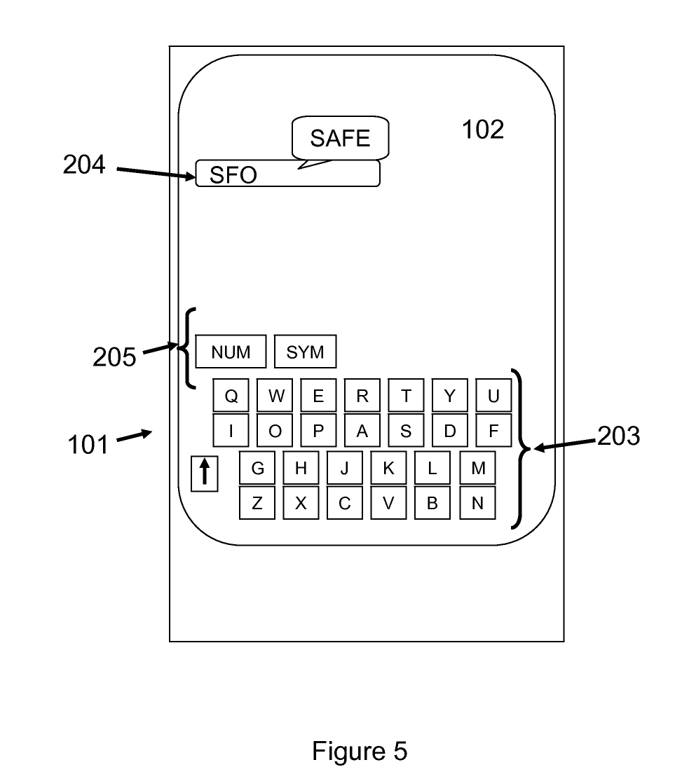

In addition the input data field 204 can be loaded with a data specifier which suppresses the spell check feature. For instance in an airline application, when input data field 204 is the airport to which the user is flying to it is expected that the input data field may be filled with data which is not in a dictionary. For instance, if the user wishes to fly to San Francisco, the spellcheck feature may propose a suggestion of “safe” if the user inputs “SFO” as shown in FIG. 5. Further, logic of the device may automatically replace “SFO” with “safe”. If the device receives the data specifier that suppresses the spell check, then the logic of the device will not replace “SFO” with “safe” and the intent of the user will be retained.

The two data specifiers (1) format data specifier and (2) spellcheck suppressor also may work in conjunction. For instance, the spellcheck may only suggest an alternate spelling if the input from the user is different than the expected format of input specified by the format data specifier.

Similarly, input data field 204 can be loaded with a data specifier which suppresses the type ahead function. For instance, when typing an airport code, a type ahead function may give an incorrect choice. Further, since airport codes are not in typical dictionaries the type ahead function will often be incorrect.

Last, the input data field 204 can be loaded with a data specifier which specifies the type of input. By loading the type of input, the spellcheck feature can provide typeaheads that are likely to match what is intended to be typed by the user. For instance if the type of input is an airport code then the logic of the device will know to use typeaheads that match airport codes. Logic of the device could perform this option by using a special dictionary for airport codes.

Generally, one of more data specifiers may be provided with an input data field.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A device that accepts input from a user comprising:
a display which displays:
an input data field for input by the user;
a displayed touchpad for typing input by the user;
wherein logic of the device is configured to receive a format data specifier with the input data field and adjust the displayed touchpad based on the format identifier and the data inputted by the user.

2. The device of claim 1, wherein logic of the device is configured to change the displayed touchpad after a character is inputted by the user.

3. The device of claim 2, wherein logic of the device is configured to change the displayed touchpad to a type of touchpad corresponding to a next expected character of the format identifier.

4. The device of claim 3, wherein the type of touchpad is an alphabetic character touchpad and the next expected character of the format identifier is an alphabetic character.

5. The device of claim 3, wherein the type of touchpad is a numeric character touchpad and the next expected character of the format identifier is a numeric character.

6. The device of claim 3, wherein the type of touchpad is a symbolic character touchpad and the next expected character of the format identifier is a symbolic character.

7. The device of claim 3, wherein the type of touchpad is a default touchpad and the next expected character of the format identifier is at least one of a null and blank.

8. The device of claim 1, wherein the logic of the device is further configured to receive a spell check suppressor with the input field and to suppress a spellcheck field if the spell check suppressor is active.

9. The device of claim 8, wherein logic of the device is configured to suppress the spellcheck if the spell check suppressor is active and input by the user matches the expected format.

10. The device of claim 7, wherein the logic of the device is further configured to receive a type identifier and configures a typeahead function to correspond to the type identifier.

11. The device of claim 1, wherein the logic of device includes an operating system.

12. The device of claim 1, wherein the logic of device includes firmware.

13. The device of claim 1, wherein the logic of device includes hardware.

14. The device of claim 1, wherein the logic of device consists of an operating system.

15. A device that accepts input from a user comprising:
a display which displays:
an input data field for input by the user;
a displayed touchpad for typing input by the user;
wherein an operating system of the device is configured to receive a format data specifier with the input data field and adjust the displayed touchpad based on the format identifier and the data inputted by the user.

16. The device of claim 15, wherein the operating system of the device is configured to change the displayed touchpad after a character is inputted by the user.

17. The device of claim 16, wherein the operating system of the device is configured to change the displayed touchpad to a type of touchpad corresponding to a next expected character of the format identifier.

18. The device of claim 17, wherein the type of touchpad is an alphabetic character touchpad and the next expected character of the format identifier is an alphabetic character.

19. A method of selecting a touchpad to present to a user on a device comprising the steps of:
receiving a format identifier corresponding to an input data field; and
displaying a touchpad on a display corresponding to a next expected input in the input data field as specified by the format identifier.

20. The method of claim 19, further comprising the steps of:
receiving input in the input data field; and
changing the touchpad displayed on the display to correspond to the next expected input after receiving input in the input data field.
